(19) United States
(12) Patent Application Publication
(10) Pub. No.: US 2010/0000064 A1
(43) Pub. Date: Jan. 7, 2010

(54) Method for manufacturing a product dispensing canister

(76) Inventor: Michael Ernest Garrett, Woking (GB)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/387,146

(22) Filed: Apr. 28, 2009

Related U.S. Application Data
(63) Continuation-in-part of application No. PCT/GB07/04159, filed on Oct. 31, 2007.

(30) Foreign Application Priority Data
Nov. 1, 2006 (GB) 06 21881.2

(51) Int. Cl. B23P 11/00

(52) U.S. Cl. 29/428

(57) ABSTRACT

A method for manufacturing a canister from which product is to be dispensed by a dispensing system comprising a solid/gas arrangement in which the gas is adsorbed on to the solid under pressure and desorbed therefrom when the pressure is released the solid comprises an adsorbent for the gas, the container being sealed and having valve for dispensing the product. The method includes filling the canister with the gas by applying a pressure of gas to the adsorbent via an aperture in the canister and sealing the canister the size of the aperture and the applied pressure being controlled such that sufficient gas is allowed freely to contact the adsorbent and achieve a pre-determined pressure in the sealed canister.

This is a Continuation-In-Part Application of pending International patent application PCT/GB2007/004159 filed Oct. 31, 2007 and claiming the priority of UK patent application 06 21881.2 filed Nov. 2, 2006.

### BACKGROUND OF THE INVENTION

This invention relates to systems for dispensing substances from containers and, more particularly, to a method of t manufacturing canisters for such systems.

A large number of products are on the general market packaged in canisters—some of which cause the product to be dispensed therefrom in the form of small or atomized particles and are therefore commonly referred to as ‘aerosols’. The particles can be dispensed from the canister by means of a gas (or vapor) pressure generated in situ in the canister, and acting as a dispensing or propellant gas. Such products include ones for personal care including hair sprays, shaving creams, deodorants and the like and ones for household use including cleaning substances, room fragrances, insect repellents or the like, and many more. In addition, many beverages, including beer and soft drinks and the like, are dispensed from canisters by means of gas pressure.

In some cases, such products are admixed with the pressurized gas in the canister and typically the operation of a push-down operating valve causes both the product and the gas to be dispensed from the canister by means of the gas pressure, for example via a ‘dip tube’ extending into the product and from a nozzle which is commonly associated with the release valve, all of which are commonly contained in a dispense assembly or dispense block.

In other cases, the product and pressurized gas are separated from each other within the canister. Typically, some form of divider or membrane is present in the canister, for example, one in the form of a bag containing the product which is sealingly attached to the canister internal wall in the vicinity of the release valve or to the valve block itself; the gas is present between the divider and the internal walls of the pack, ie surrounding the bag and the gas pressure in turn exerts pressure on the product in the bag.

Alternatively, the divider may be a piston which slides within the canister with the product on one side and a gas on the other side and which acts to drive the product from the canister by the action of gas pressure.

Whichever type of pressure pack is adopted will depend on the nature of the product and the use to which it is to be put and on the nature and properties of the propellant gas, in particular whether the propellant gas might react with the product or whether, for example, it might be flammable or odorize the product.

The use of chlorofluorocarbons (CFCs) previously became very popular as propellant gases for such product dispense canisters in that they can be readily condensed and vaporized in a reversible manner responsive to the surrounding pressure. This was followed by the use of hydrofluorocarbons (HFCs) and also hydrochloroflurocarbons (HCFCs) which were regarded as being somewhat more environmentally friendly.

However, more recently, such propellant gases have in general been phased out owing to their acknowledged environmentally harmful properties, in particular ozone depletion of the upper atmosphere.

Alternative propellant gases which have been commonly used are certain hydrocarbon gases including liquid petroleum gases (LPGs) such as propane and butane. Such gases, however, are by their nature extremely flammable, are environmentally harmful in some respects and in addition can introduce an odor in to the product being dispensed.

It is known that numerous attempts have been made to replace LPG propellant gases with gases such as permanent gases, for example air, nitrogen, carbon dioxide, nitrous oxide and the like. These attempts have largely been effected simply by utilizing a pressurized gas within the canister. In practice, the canister valve is depressed to propel the product from the canister in the general manner described above.

However, such attempts have been largely unsuccessful due to the large pressure changes in the canister during use, commonly leading to reduced dispense characteristics at low pressures and a loss of pressure before full product dispense which results in a slow dispense of the last product from the canister.

In addition, it is known that there has been considerable effort to develop further alternative propellant systems for such product dispense. For example, there is disclosed in European Patent Application No. 385 773 the use of two-phase gas/solid or gas/liquid or three phase gas/liquid/solid propellant systems in which the solid is a polymer having molecular microvoids occupied by the gas or gas/liquid under pressure and the gas is released therefrom when the pressure of the system is reduced.

There is additionally disclosed in a further European Patent Application No. 502 678 the use of a three phase gas/liquid/solid propellant system in which the solid is a material such as a foam or a fibrous mass having open voids occupied by the gas/liquid under pressure and the gas is released therefrom when the pressure of the system is reduced.

It is known that efforts to develop such prior systems were based primarily on the preferred embodiments described in these European applications, namely the use of a gas/liquid/solid system in which carbon dioxide as the gas was dissolved in acetone as the liquid which itself occupied voids in a solid.

The use of acetone as the liquid in such a system would generally mean that it was useful only in canisters employing a membrane, for example a bag containing the product, in order to separate the propellant system from the product to be dispensed. However, acetone is an aggressive chemical and it was also found that the use of acetone in such systems tended to cause problems associated with chemical attacks of the membrane material and leakage of the acetone through, and around, the membrane resulting in failure of the membrane.

A further prior attempt to produce a product dispense system utilizing gas pressure is disclosed in UK Patent Specification No. 1 542 322 in which a propellant gas, including propane/butane, certain CFCs and carbon dioxide, is adsorbed on to a solid with dispense gas pressure being produced in situ during use of the system by means of bringing the solid in to contact with a propellant displacing agent—preferably water—in order to release the adsorbed gas. As such, the system as a whole is necessarily very complex due in particular to the need to employ the propellant displacing agent during use and provide means to bring it in to contact with the solid.

It was also disclosed in our co-pending Application PCT/GB2005/000145 that the use of a new system not involving polymeric materials and not involving troublesome liquids or displacing agents and being more suitable for commercially viable assembly in to the aerosol canister can provide an efficient sorption/desorption propellant system for product dispense.

In accordance with the disclosures of this prior application, a dispensing system for dispensing a product from a canister is provided which comprises a solid/gas arrangement in which the gas is adsorbed on to the solid under pressure and desorbed therefrom when the pressure is released and in which the solid comprises activated carbon and the gas comprises one or more of nitrogen, oxygen (or mixtures thereof including air), carbon dioxide, nitrous oxide and argon, the canister having valve means to allow the gas adsorbed on to the carbon to be desorbed and effect product dispense.

The gas is preferably carbon dioxide in view of its generally superior adsorption characteristics in relation to activated carbon as an adsorbent.

The term ‘adsorbed gas’ used herein refers to the gas used in the system according to the invention.

It was found that such a system, despite its simplicity, can provide the basis for an efficient, safe, reliable and reproducible system for product dispense.

It was further found in particular that the new dispense system can provide—by means of careful selection of the type of activated carbon employed, the amount of carbon, the initial pressure and therefore the amount of gas adsorbed on the carbon—a low pressure change during intermittent use between an initial product dispense and full product dispense from a canister.

The small pressure change afforded by this system between a ‘full’ and ‘empty’ canister is such that the canister in which it is positioned can maintain an effective discharge of product with an effective and acceptable controlled spray pattern in terms in particular of its being uniform and/or homogeneous with a predetermined particle size and distribution.

Such systems have been shown to be particularly suited to the dispensing of products from small, hand-held ‘aerosol’ canisters, for example ones having a 200 or 300 ml capacity. The term ‘aerosol’ when used herein includes any hand-held dispensing devices for the delivery of product whether or not the product is actually atomized or whether or not it incurs any other form of product break-up.

In accordance with the prior disclosures, the dispensing system is preferably incorporated in to a canister in which a product to be dispensed is held under gas pressure. In such embodiments, carbon dioxide desorbed from the carbon adsorbent pressurizes the canister and maintains the pressure therein generally and during actuation of the canister dispensing valve in particular.

Preferably, the product and the solid/gas arrangement are present in separate compartments in the canister. This is primarily to keep the product and the solid apart from each other in order to hold the solid in a predetermined part of the canister and/or to ensure in particular that the product, which may for example be in aqueous or other type of solution, does not contaminate the solid and thereby detract from its efficiency of adsorption.

In some instances, the compartments may be separated by means of a wholly or substantially impermeable membrane. This membrane may take the form of a flexible bag which is sealingly attached either to the interior wall of the canister (sometimes known as ‘bag-in-can’) or to the canister operating valve or dispense block (sometimes known as ‘bag-on-valve’) and which in use holds the product to be dispensed. The solid/gas arrangement is generally positioned within the canister outside the bag such that pressure is exerted on the exterior of the bag when pressure therein is released on actuation of the valve and product dispense effected via the valve through a nozzle. An elastic material may be employed to form the bag.

Furthermore, the membrane, whether of elastic or non-elastic material may be used and may be sealingly attached to any relevant part of the canister interior.

The substantially impermeable membrane may alternatively take the form of a piston slideably mounted in the canister interior with the gas/solid arrangement on one side of the piston and the product to be dispensed on the other side such that actuation of a dispense valve causes pressure from gas desorbed from the solid to move the piston and urge product to be dispensed from the canister via the valve.

In other instances, the compartments may be separated by means of a fixed partition. Such a fixed partition may usefully be positioned in the any useful part of the canister, and preferably including the base thereof, to form the solid/gas arrangement compartment therein. It can, for example, be a concave-shaped disc in a ‘flat’ canister base or one of greater concavity than the (usually) concave-shaped canister base (as viewed from the exterior of the canister). It may advantageously be crimped to the canister between the canister wall(s) and its base to form an annular compartment between the disc and the base.

The solid compartment may also be in the form of a container or ‘widget’ that may be fixed to the canister (or part thereof) or allowed to be free within the canister interior.

In addition, the carbon container may be associated with the canister dip tube, for example by being mounted around the dip tube for ease of assembly of the canister generally and the positioning of the container therein and, separately to allow for a ready filling of the container with adsorbed gas via the dip tube and via a one-way valve therebetween.

Generally, the product and the solid/gas arrangement of the dispensing system are present in individual compartments in the canister, which are separated by a partition which may be fixed or displaceable. This keeps the product and the solid apart from each other in order to hold the solid in a predetermined part of the canister and/or to ensure in particular that the product, which may for example be in aqueous or other type of solution, does not contaminate the solid and thereby detract from its efficiency of adsorption.

With a fixed partition, for example the substantially rigid wall of the carbon container, it is generally required that the gas from the solid/gas compartment can flow in to the product compartment, but not vice versa, and this can readily be effected by having a one-way valve in the partition.

Equally, there was a general need to provide means to allow the introduction of carbon dioxide in to the solid/gas compartment prior to use of and during use of the system; this can also be effected by a one-way valve to prevent back flow of the gas from the solid/gas compartment.

Each one-way valve should be designed such that is operates only under a certain applied pressure, for example a small fraction of 1 bar; otherwise the valve does not open.

With certain valve designs, it is possible for a single valve to operate as a pressure sensitive valve in either direction depending on the requirements of the system.

In such embodiments, the container for the carbon should have one-way valve means in order to allow the carbon dioxide to be desorbed from the solid and pass in to the product compartment when the pressure in the canister falls, ie on operation of the canister dispensing valve, and thereby maintain canister pressures at predetermined levels for further use of the aerosol.

In all cases, the one-way valve means may be made from any material and be of any suitable form including ones incorporated integrally in to the body of the carbon container. One form which is particularly useful may comprise an upstanding valve body terminating in a parallel, double plate arrangement—preferably formed integrally with the wall of a product bag or fixed partition—such that the plates act as a closed valve in their usual position but which can move under their inherent resilience to an open position by virtue of gas pressure effective thereon in a predetermined (single) direction, i.e. from the interior of the carbon container. Such a valve is sometimes referred to as a ‘sphincter’ valve.

The one-way valve advantageously is formed integrally with the partition and is preferably made from a plastic material, for example PET or silicone rubber.

With a displaceable partition, this will generally be impermeable to the gas and may take the form, for example, of a bag for holding the product or a piston slideable within the canister with the desorbed gas from the carbon deforming the bag or moving the piston within the canister under the increased gas pressure applied thereon during actuation of the dispensing valve.

In other embodiments, the dispensing system may be implemented with a product not held before its dispense under gas pressure. In such embodiments, the desorbed gas is not used to effect product dispense until it is required in use. These embodiments may be put in to effect by restraining the gas pressure in the solid/gas container and effecting its release therefrom via valve means only when required during product dispense.

In these embodiments, the desorbed gas may be used to effect product dispense by:

i) causing the desorbed gas pressure to act directly on a product to effect product dispense, for example by urging the product through a dip tube inserted in to the product in the canister, or

ii) causing the desorbed gas pressure to act indirectly on the product to effect product dispense, for example by its impingement on to a piston slideably mounted in a canister body or part thereof, or

iii) causing the desorbed gas to effect product dispense by fluid dynamic (fluidic) action through the formation of a vacuum in to which a product is drawn, sucked or otherwise urged, for example by causing desorbed gas to flow through a venturi in which the gas flow is increased and the pressure is decreased in the ‘throat’ thereof, ie a partial vacuum is formed, and to which the product container can be linked to effect product dispense.

In these separate embodiments, it was disclosed that it may be advantageous—especially in regard to paragraphs i) and ii) above—to provide valve means to release the pressure applied directly or indirectly to the product to effect its dispense when the canister is not being used.

Use of the separate embodiments with an unpressurised canister is particularly useful in the case of a product in which the propellant gas can dissolve.

In all such embodiments, the carbon is advantageously held in a container which is preferably proximate to the dispensing block, for example by being attached thereto or may be less firmly linked, for example via a tube through which the carbon dioxide can be introduced in to the container.

In such preferred embodiments, the dispensing block itself advantageously incorporates a canister dispensing valve and passageways linking the interior of the canister with the exterior thereof via the valve. As such, the dispensing block, together with the carbon container, can readily and effectively be sealingly inserted in to an aperture in the canister during canister assembly.

In particular, the linkage of the container to the dispensing block generally allows firstly for a ready operation of the pressure pack and secondly allows for a simple mode of manufacture and assembly of the aerosol canister by allowing for the dispensing block—incorporating the canister dispensing valve, necessary passageways linking the interior of the canister with the exterior thereof, and also the carbon container linked thereto—to be inserted in to an aperture in the canister, ideally the top of the canister, advantageously in a single assembly step.

The invention therefore allows standard designs of canister to be employed without modification to the body thereof in order to suit implementation of the invention generally and to include canisters made of either steel or aluminum or other material.

In preferred embodiments, the dispensing block and the carbon container are advantageously joined, for example by being made as an integrally formed unit, for example with the carbon container being situated beneath the dispensing block in a normal upright orientation of the canister. It is also advantageous for a dip tube to depend from the dispensing block, preferably being positioned centrally (axially) in the carbon container and, in use of the propellant system, extending in to the body of the canister within the product to be dispensed.

The container for the carbon can be, for example, made of a flexible plastic/polymer material in the form of a bag or alternatively be cylindrical in shape and advantageously made from a more rigid material, again preferably from a plastic/polymer material. The container is preferably cylindrical in shape.

In general, it is preferred for the carbon to be placed in the container prior to the final assembly of the canister, i.e. prior to insertion of the dispensing block and in to the product itself to which the container is linked in to the canister aperture as described above.

The product to be dispensed by the system of the invention is commonly inserted in to the canister via a dip tube depending from the dispensing block and through which, in use of the aerosol, the product is dispensed via the dispensing valve in the reverse direction. The solid/gas container is advantageously linked to the dispensing block, for example by being positioned co-axially about the dip tube and as such can be regarded as an integral part of the dispensing block. In such cases, the block as a whole can therefore readily be placed in a canister aperture simultaneously during canister assembly.

Means must also be provided for the introduction of the gas under pressure in to the carbon container in order to cause it to be adsorbed on to the carbon and subsequently desorbed therefrom on operation of the dispensing valve. This can be effected, for example, by providing a suitable route via the dispensing block in to the container interior and including (as described above) a one-way valve to prevent back flow of the gas. Alternatively, in the case of a bagged product canister, a small so-called ‘bung hole’ is present in the wall or, more usually, the base of the canister which is plugged by a rubber or other polymeric seal to retain the gas in the canister. Such a bung hole system is not, however, preferred as it may lead to gas leakage from the canister.

Overall, therefore, the product dispensing system provides a simple and effective way of utilizing gas desorbed from the adsorbent per se in order to provide a sufficient gas volume to produce an initial gas pressure and thereafter to maintain gas volumes, and necessary gas pressures, to enable a complete product dispense to be effected.

In all embodiments, a pressure regulator may be used to regulate the gas pressure released from the adsorbent of the dispense system of the invention to a predetermined pressure level or within a predetermined range of pressure. For example, a 10 bar(a) pressure provided by desorbed gas may be regulated to produce propellant gas at 3 bar(a).

With regard to the gas and in relation to all embodiments of the invention, it should be introduced in to the dispensing system under pressure and which will be adsorbed on to the carbon such that its molecules are much more closely packed together than in the usual gaseous form at the same temperature and pressure.

This means that, when the gas is introduced under pressure in to a “gas space” surrounding the carbon, considerably more gas will be adsorbed on to the carbon. Consequently, as the system is activated, typically by actuating the pressure release valve, there will in practice be only a relative and surprisingly small pressure reduction within the system which, in use of the system, therefore allows for the effective dispensing of all of the product.

It was disclosed in our prior specification that the gas, especially in relation to carbon dioxide, may be introduced in to the canister in gaseous, liquid or solid form.

With regard to the use of liquid carbon dioxide, adding the gas in this way will generally produce a mixture of carbon dioxide snow and cold carbon dioxide gas can in practice at least partially thermally balance the heat of adsorption of the carbon dioxide on to the carbon and maintain temperatures close to ambient.

It was also disclosed that a double valve arrangement may be employed for measuring exact quantities of liquid carbon dioxide present between two valves positioned in a delivery tube of constant cross-section so as to define the required volume of gas needed for each canister as they pass along a conveyor assembly line. This is preferably effected by closing the upstream valve once the required volume of carbon dioxide is present between the valves and allowing the volume to ‘vaporize’, and to urge the stream of snow/gas in to the canister.

The gas may also be charged in to the container in the form of solid carbon dioxide which is easy to handle and affords the benefits described above for liquid carbon dioxide.

Activated carbons are well known per se and have the advantage that they are relatively inexpensive; they are non-polymeric substances. In general, activated carbons are manufactured from a variety of carbonaceous materials including (1) animal material (blood, flesh, bones, etc), (2) plant materials such as wood, coconut shell, corn cobs, kelp, coffee beans, rice hulls and the like and (3) peat, coal, tars, petroleum residues and carbon black.

Activation of the raw carbonaceous materials can be effected in a variety of known ways including calcining at high temperature (e.g. 500° C.-700° C.) in the absence of air/oxygen followed by activation with steam, carbon dioxide, potassium chloride or flue gas at, say, 850° C. to 900° C., followed by cooling and packaging.

Selected activated carbons are suitable for use in the systems of the invention, for example ones having a density of from 0.2 g/cm³ to 0.55 g/cm³, preferably 0.35 g/cm³ to 0.55 g/cm³.

The quantity of carbon required in implementing the invention will vary depending on parameters including the gas employed, the initial and final pressures during the dispense of product, the nature of the product and its physical characteristics and the desired properties of the dispensed product. As such, the carbon may advantageously occupy from 5 to 95% of the canister interior volume.

In the case of a standard size (300 ml) canister, it is preferred for many product types to have a carbon content of from 5 to 30% of carbon (by volume) which generally equates, for selected carbons, to the presence of 10 to 60 ml of carbon, more preferably 30 to 50 ml of carbon, for example 40 ml of carbon.

With other product types, especially those of relatively high concentration of active ingredient(s), the carbon content may usefully be from 30 to 95%, preferably from 60 to 90%.

In the case of the higher concentration products in particular, but also generally, the product dispensed from the nozzle of a canister may advantageously be improved by causing a separate bleed of gas to be directed in to the dispensing valve or block and therein to mix with product being expelled therefrom in order to effect a greater dispersion of the dispensed product.

Such improvements are especially useful with more concentrated and/or more viscous products which might otherwise be difficult to disperse adequately for effective spray pattern or whatever.

For certain embodiments, it was disclosed that the activated carbon is present in the form of one or more pellets or torroids, ie in a much larger size than the granules in which it is normally supplied, for example of a size of at least 0.5 cm in length or greater. Such pellets or torroids may be fabricated by sintering or other binding processes and preferably will allow for a much larger surface area for the carbon dioxide and therefore a commensurately larger and more effective gas release on reduced pressure.

The pellets or torroids can advantageously be manufactured as sticks or tubes and/or with surface ribs or grooves or with apertures therethrough; all such forms can be capable of aiding adsorption/desorption of the gas.

In general, specific ways of treating and/or handling the carbon are important aspects of the invention and may be essential for the implementation of the dispensing systems.

In particular, it has been found that there may be a propensity for the required properties of the carbon to degrade after the carbon activation process. Such degradation may include adsorption sites on the carbon being blocked by a gas or gases present in the atmosphere present around the carbon and which cannot subsequently be displaced by the gas that is to be adsorbed as the working gas in the dispensing systems of the invention. Although the blocking process may be reversible in certain cases, displacement by the preferred gas may not be effected completely and therefore would detract from the subsequent adsorption of the gas. In some instances, desorption of the initially held gas may be aided by high temperature and/or vacuum.

Preferably, therefore, the activated carbon is held, advantageously from the time of its production, under a protective, blanketing atmosphere. This atmosphere may comprise the adsorbed gas itself, ie the gas that will be used to effect dispense of product, or a gas or gases (including mixtures with the adsorbed gas) that do not prevent the adsorbed gas subsequently occupying the carbon adsorption sites, in particular by virtue of being held at the adsorption sites on the carbon less strongly than the adsorbed gas. In the case of carbon dioxide as the protective gas, the blanketing of the adsorbent may be regarded as a pre-saturation of the adsorbent with carbon dioxide.

It should be noted that the activated carbons may occasionally require some additional treatment(s) including in particular heat treatments in order to reactivate and/or regenerate the full characteristics of the carbon. Such additional treatment(s) are included in the term ‘manufacture’ and/or ‘activation’ throughout this specification and the appended claims.

Certain gases, including water vapor, are more strongly held at the carbon adsorption sites than the adsorbed gas and carbon dioxide in particular and therefore should be rigorously excluded from the atmosphere around the carbon; subsequent attempts to dislodge the strongly held gases will not be successful.

Although some gases are less strongly held at the adsorption sites than carbon dioxide and other adsorbed gases, they may still interfere with the subsequent adsorption efficiency characteristics of the adsorbed gas and should be avoided as blanketing gases.

In the case of carbon dioxide as the adsorbed gas, the blanketing atmosphere preferably includes or comprises carbon dioxide itself. This can be especially advantageous in the implementation of dispensing systems when the carbon dioxide is preferably adsorbed on to the carbon at elevated temperatures.

Other suitable gases include helium and hydrogen, the former of which in particular is generally capable of providing a protective atmosphere about the adsorbent and thereby preventing unwanted adsorption by other gases. The potential use of other blanketing gases can be established by a skilled adsorption scientist on a theoretical or practical basis.

Adsorption is an exothermic process in which considerable amounts of heat may be generated. The adoption of these preferred embodiments with a blanketing atmosphere that includes carbon dioxide itself is beneficial in that it allows an initial level of adsorption of carbon dioxide to occur—together with the avoidance of subsequently generated heat of adsorption—prior to the use of the carbon in the dispensing systems. This can lead to significant advantages from the resultant lower amounts of heat generated when the remaining carbon dioxide is adsorbed under pressure in subsequent high speed production of canisters incorporating the dispensing systems.

With all adsorbed gases, the blanketing of the carbon is preferably effected from the time of manufacture of the adsorbent and is preferably maintained continuously up to the time of (final) assembly of the canisters in which the dispensing systems are employed. To achieve this, the use of containers for holding the blanketed carbon is required in order to isolate the carbon from undesirable gases.

In any event, the carbon granules (or pellets or torroids) may advantageously be pre-saturated with carbon dioxide (or other adsorbed gas) prior to use, and the saturation thereafter maintained, in order to improve the adsorption parameters. The granules/pellets/torroids may be advantageously cooled in such pre-saturation processes by use of cooled carbon dioxide, for example carbon dioxide solid or snow being in contact with the carbon.

Preferably, the carbon granules/pellets/torroids are usefully kept in contact with a source of carbon dioxide or other adsorbed gas, especially cold gas, liquid or snow, prior to placement in a canister and this may provide sufficient adsorbed gas for use in the system without the need to add further amounts of gas.

In the case of certain products, it has been found that it may be useful for optimum dispense characteristics to pre-treat the product with adsorbed gas prior to, or during, its introduction in to the canister. This can be especially useful in the case of highly soluble gases such as carbon dioxide, i.e. ‘pre-carbonation’. Such a process is more useful in the case of product to be admixed with the adsorbed gas in the canister; it may, however, also apply to product present in the canister separated from the adsorbed gas by a moveable partition including a bag whether or not the partition allows for a certain leakage of gas therethrough.

As stated above, however, the gas for adsorption on to the activated carbon may, in the case of carbon dioxide in particular, be introduced during manufacture of the dispensing system in the canister from gaseous, liquid or solid sources. Gaseous carbon dioxide, for example from a cylinder or from a source of liquid carbon dioxide which is vaporized during the manufacture of the system is preferred for reasons including ease of handling. Problems may arise, however, in striving to ensure that sufficient gas is introduced in to the canister during its manufacture at a rate which is commensurate with required commercial filling line speeds. These problems are particularly acute in the present case in that considerably more carbon dioxide is required in the canister due to the presence of adsorbent therein and the amount of gas to be adsorbed thereby.

It has generally been found that the use of techniques currently available to skilled gas technologists are not capable of allowing gasification to occur at speeds required for commercial filling lines. Using currently commercially available activated carbons, attempts at high speed gasification of canisters have been shown to result in the generation of considerable amounts of heat caused by heat of adsorption and adiabatic heating phenomena. In order to avoid the resulting high temperatures leading to potential melting of canister components and the generation of dangerous, illegal high internal pressures in the canister, it is generally necessary to adopt a multi-step process with lengthy periods, for example of several minutes, between each step to allow for cooling of the canister and its components in order to obviate the high temperatures.

As a result, attempts to date to effect a speedy gasification, especially in the present case where the adsorbent needs to adsorb considerable amounts of gas, have been inadequate or even generally unsuccessful.

In particular, the supply of carbon dioxide (or other) gas through a bung hole of standard size, for example in the base of a bag-in-can canister, or via an orifice in the valve block in, for example a bag-on-valve canister—both of which are necessarily relatively small in cross section—has been found to require filling times for the introduction of sufficient gas in to the canister greatly in excess of commercial requirements.

It is the object of the present to provide a method of manufacturing and filling a canister for product dispense which overcomes such problems.

### SUMMARY OF THE INVENTION

In accordance with the invention, there is provided a method for manufacturing a canister from which product is to be dispensed by means of a dispensing system comprising a solid/gas arrangement in which the gas is adsorbed on to the solid under pressure and desorbed therefrom when the pressure is released and in which the solid comprises an adsorbent for the gas and the gas comprises one or more of nitrogen, oxygen (or mixtures thereof including air), carbon dioxide, nitrous oxide and argon, the canister being adapted to be sealed and having valve means to cause product to be dispensed by means of the pressure of the adsorbed gas, wherein the method includes filling the canister with the gas by applying a pressure of gas to the adsorbent for adsorption thereon via an aperture in the canister and sealing the canister and wherein the sizes of the aperture and of the applied pressure are controlled such that sufficient gas is allowed freely to contact the adsorbent and achieve a pre-determined pressure in the sealed canister.

It is particularly advantageous if the solid adsorbent is pre-charged with the adsorbent and is installed in the canister in a pre-charged condition

Product dispense canisters made by the method of the invention are also included in the scope of the invention.

For reasons of low cost, environmental acceptability including its disposal and generally good adsorption characteristics, the adsorbent is preferably activated carbon; the description hereafter will concentrate on this particular adsorbent. Alternative adsorbents include a variety of zeolytes which may be selected to act in substantially the same general manner as activated carbons with adsorbed gases including carbon dioxide.

With regard to the applied pressure, this is advantageously in excess of a required pressure (P1) in the canister by an amount of at least five percent (5%), preferably at least ten percent (10%) and more preferably at least twenty percent (20%) of the required pressure.

In this respect, the required pressure (P1) is that which is needed to provide an internal canister pressure, preferably based on an equilibrium pressure established when, for example, the temperature has returned to ambient. It should be noted that the required pressure (P1) should be calculated to take account of whether it is established by the method of the invention with (1) product to be dispensed already present in the canister or (2) product to be dispensed to be subsequently introduced in to the canister, i.e. after the gassing process, the latter of which will result in an increased pressure in the canister.

The applied pressure advantageously remains in force up to the time of sealing the canister and preferably the canister aperture is sealed whilst the applied pressure is still being maintained.

With regard to the aperture, this should be sized such that sufficient gas is allowed freely to come in to contact with the adsorbent and, once the canister is sealed, to achieve a pre-determined pressure (preferably once pressure equilibrium has been attained) in the canister interior.

The invention is especially applicable to canisters operating with a ‘bag-in-can’ or ‘bag-on-valve’ mode of use.

In the case of a bag-in-can arrangement in which the product bag is designed to be secured, in use, to the canister internal wall or about its aperture, a large aperture in the canister wall or base is necessary in order to allow for a fast, i.e. free, injection of gas in to the canister. The invention, however, allows the gas injection to be effected via an annular gap between the bag exterior and the internal canister wall; this gap is commonly of the order of 1 to 10 mm in width. The diameter of the aperture itself is usually at least 20 mm, more usually at least 25 mm.

With a bag-in-can arrangement, the product is conventionally placed in the product bag before gassing of the carbon occurs, commonly by means of a ‘bung hole’ in the base of the canister. In accordance with method of the invention, however, the product may be placed in the product bag after gasification of the adsorbent has occurred, for example via the annular gap between the bag exterior and the internal wall of the canister aperture.

In the case of a bag-on-valve arrangement in which the product bag is secured to the canister valve or valve block, the gas injection may advantageously again be effected via the annular gap between the valve/valve block aperture and the aperture itself prior to the final positioning of the valve block/valve block therein. The diameter of the aperture is again usually at least 20 mm, more usually at least 25 mm.

With a bag-on-valve arrangement, the product is usually placed in the product bag after gassing of the carbon has occurred, for example via the valve block following its sealing in to the canister aperture.

Whatever arrangement is employed, the aperture should be sealed as quickly as possible after the gas injection so as to minimize gas leakage from the canister. In particular, it is advantageous for the gas filling pressure to be kept applied until sealing of the aperture has occurred; most preferably, the filling process includes a filling head for the gas supply and has associated therewith means to maintain the aperture seal in place until the filling head is withdrawn.

The gas is preferably supplied to the aperture by means of a supply pipe that delivers the gas to the aperture and has means, for example an annular shroud, to form a seal about the canister aperture during the gassing process.

The crux of the invention is the realization that a fast gassing of the carbon to provide pre-determined pressures is possible if the gassing pressure and the aperture size are correlated and carefully controlled in relation to each other and in particular in order that the applied pressure is a function of one or more of:

(1) the gas filling time,

(2) the size of the filling aperture,

(3) the size of the canister,

(4) the amount of adsorbent, and

(5) the required final pressure in the canister.

All these inter-related parameters are capable of being determined by a skilled gas scientist. The overall result may be regarded as a ‘dynamic’ process for canister filling.

Advantageous and important preferred embodiments of the invention include:

(i) the flushing of the canister interior with carbon dioxide (or other adsorbent gas) prior to the pressurized gas filling in order in particular to obviate the adiabatic heating of air that would otherwise be present in the canister and thereby prevent any unnecessary and detrimental pressure/temperature rise and additionally to prevent any air adversely affecting the desired pressure ratio in the canister between initial and final product dispense;

(ii) the use of adsorbent which has been pre-saturated with adsorbed gas prior to insertion in to the canister

(iii) the use of adsorbent which has been blanketed with adsorbed gas, preferably from its point and time of manufacture (or final manufacturing step) up to its point and time of use in the canister during the method of the invention. In the case of carbon dioxide in particular as the adsorbed gas, this is especially useful if the gas is to be introduced in to the canister in gaseous, as opposed to liquid or solid, form.

The invention therefore generally allows for a fast gas (and product) filling time together with a precise and critical control of the resulting pressures in the sealed canister during the manufacturing method and subsequently in order to achieve the required start and residual dispense pressures.

The control of the rise in temperature (and the resulting control of pressures) emanating from the heat of adsorption is possible by the use of the invention generally and is enhanced by the use of blanketed carbon in particular.

In preferred embodiments of the method of the invention in order to achieve optimum filling characteristics, the method includes:

(i) the use of the inter-relationship of canister aperture, filling pressure, final canister pressure and gas filling time;

(ii) the use of a predetermined applied pressure to the aperture necessary for the production of the initial internal pressure;

(iii) the use of adsorbent, especially activated carbon, that has been protected and pre-saturated with adsorbent gas, for example carbon dioxide, and therefore blanketed with the gas from the time of its manufacture.

Use of the invention in general and with particular reference to the use of these preferred embodiments in practice affords the possibility of applying the invention to a bag-in-can canister in which gasification of adsorbent contained, for example, in the base of the canister is effected by the application of a gas source around the canister aperture with the bag-in-can loosely held within the canister, and thereafter closure of the space between the canister body and the bag effected by sealing the bag to the canister aperture by means of inserting the valve block in to the aperture with the bag sealingly and permanently held therebetween.

Such a procedure, for bag-in-can canisters in particular, obviates the need for gasification of the adsorbent via the commonly used aperture in the base of the canister and the use of an associated valve/bung to effect closure of that aperture. Indeed, the absence of a base aperture and associated valve/bung renders the canister as a whole less expensive to manufacture in terms both of cost of materials and simplified filling procedures.

In respect of bag-in-can canisters in particular, the product bag preferably has an initial cross section such that it may be inserted in to the canister aperture without the need for any substantial deformation/distortion. The bag may also advantageously be constructed so that it may be expanded within the canister following its insertion therein. This expansion may be effected, for example, by virtue of the bag being constructed with longitudinal folds or fluted across its surface, or alternatively by virtue of properties of the bag material to afford, for example, a non- or partial elastic behavior.

Use of the method of the invention in general and such a procedure in particular affords the possibility of introducing the product to be dispensed after the gasification procedure has been effected, for example via a passageway in the valve block.

This control of, and limitation of, the temperature reached during the manufacturing method of the invention affords the possibility of an alternative to the separate pressure testing of each canister—currently required by means of water bath immersion at 50 degrees C. —by simply ensuring that each canister reaches the required temperature as part of the manufacturing method.

In preferred embodiments of the invention, the aperture through which the gas pressure is applied is in the wall of the canister itself. In other embodiments, however, the invention also encompasses the possibility of the aperture being accommodated in the wall of a separate container or compartment in (or associated with) the canister.

These other embodiments apply in particular to dispense systems previously described in this specification in which the adsorbent is held in the separate container or compartment, for example:

i) when the adsorbent is in a container formed integrally with the valve block (or is associated therewith);

ii) when the adsorbent is in a compartment in the form of a widget or container that may themselves be fixed to the canister or allowed to be free within the container;

iii) when the system is implemented with a product not held before its dispense under gas pressure, and the gas pressure is in a solid/gas container and is released therefrom only when required during product dispense.

Containers of dispense systems prepared in accordance with the method of the invention and being suitable for use or adapted for use in dispense canisters are also specifically included in the scope of this invention.

The invention will become more readily apparent from the following description of an exemplary embodiment thereof described below with reference to the accompanying drawings:

### BRIEF DESCRIPTION OF THE DRAWINGS

FIG. 1 shows a schematic cross-section of a ‘bag-on-valve’ canister in ‘exploded’ form showing its components prior to final assembly using the method of the invention, and

FIG. 2 shows a schematic cross-sectional view of a ‘bag-in-can’ canister showing its components prior to final assembly using the method of the invention.

### DESCRIPTION OF A PARTICULAR EMBODIMENT

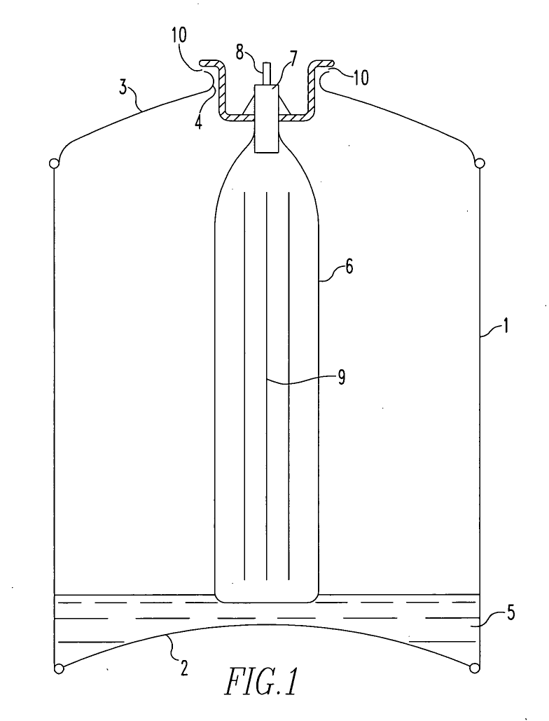

With reference to the drawings and to FIG. 1 in particular, there is shown a canister comprising a cylindrical main body 1 having a base portion 2 sealingly attached thereto around its base (as shown) perimeter. A canister top portion 3 is sealingly attached to the main body 1 around its upper (as shown) perimeter and has a centrally positioned aperture 4 therein.

Situated in the lower part of the body 1 and resting on the base portion 2 is a predetermined amount of activated carbon adsorbent 5 that has been pre-saturated/blanketed with a carbon dioxide atmosphere from the time of its manufacture, i.e. activation, until loaded in to the body 1. The interior of the body 1 has previously been flushed with carbon dioxide in order to dispel at least most of the atmosphere therein just prior to the loading of the carbon absorbent 5 therein.

A ‘bag-on-valve’ 6 is shown in the drawing in its position at the time of gasification of the canister together with a valve block 7 (incorporating a canister operating valve mechanism) and associated actuator 8, all in proximity to, but not sealingly inserted in to the canister aperture 4. Longitudinal folds or pleats 9 in the bag material afford readily insertion of the bag through the aperture 4 prior to gasification of the canister and thereafter allow its contraction/expansion in cross-sectional size in particular depending on the pressures applied thereto.

A gasification head (not shown) is used to supply carbon dioxide under pressure to an annular aperture 10 formed (and as shown in the drawing) between the bag 6 and the aperture 4 in the top portion 3.

The head also includes means (not shown) to push the valve block 7 and bag 6 firmly in to the aperture and engage it therein so as to effect a permanent sealing between the aperture 4, the bag 6 and the valve block 7 and thereby maintain a pressure of carbon dioxide in the space between the body 1 and the bag 6.

The bag 6 as shown in the drawing is in its initial form. Introduction of the gas between it and the canister body will cause its contraction in shape inwardly by virtue of the fold/pleats 9 in its construction. The subsequent introduction of product material into the bag 6 will cause its expansion within the confines of the canister body (and subsequent contraction as the product is dispensed during use of the canister).

Subsequent introduction of a product to be dispensed from the canister is introduced into the interior of the bag 6 through the valve block 7.

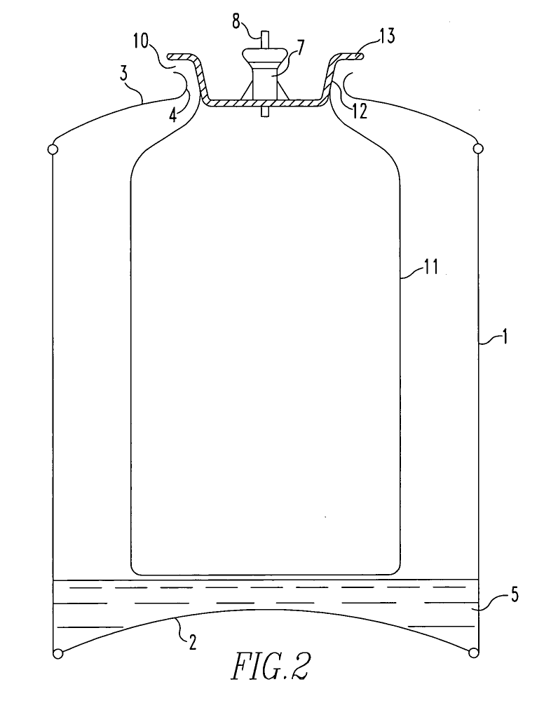

Turning to FIG. 2, a arrangement similar to that of FIG. 1 is shown in this figure except that the bag-on-valve is replaced by a bag-in-can 11. All the other components are generally the same except as described below.

The bag-in-can is made of a flexible polymeric material so that it can be inserted into the canister through the aperture 4. It expands upon introduction of the product being introduced therein after gasification of the canister to contracts during product dispense.

The bag-in-can neck 12 is held relatively loosely around a correspondingly shaped flange 13 of the valve block 7 (as shown in FIG. 2) prior to gasification by the method of the invention; an annular gap is also formed between the bag-in-can neck 12 and the aperture 4 in the canister top portion 3. Gasification is effected in the same manner as described for FIG. 1.

Applying the method of the invention to the canister shown in the drawing, preferred gas filling times are from 0.5 to 2.5 seconds, for example 1 or 2 seconds. In order to achieve such short filling times, the filling pressure has to be adjusted to allow the gas to be freely introduced to the carbon via a sufficiently sized aperture.

What is claimed is:

1. A method for manufacturing a canister from which a product is to be dispensed by means of a dispensing system comprising a solid/gas arrangement in which the gas is adsorbed onto the solid under pressure and desorbed therefrom when the pressure is released and in which the solid comprises an adsorbent for the gas and the gas comprises at least one of nitrogen, oxygen and mixtures thereof including air, carbon dioxide, nitrous oxide and argon, the container being adapted to be sealed and having valve means for dispensing the product by means of the pressure of the adsorbed gas, the method comprising the steps of: filling the canister with the gas by applying pressurized gas to the adsorbent for adsorption thereon via an aperture in the canister and sealing the canister the size of the aperture and of the pressure applied being controlled such that the gas is allowed to freely contact the adsorbent and achieve a pre-determined pressure in the sealed canister is achieved.

2. A method according to claim 1, wherein the adsorbent is activated carbon.

3. A method according to claim 1, wherein the applied pressure exceeds the required pressure in the canister by at least 5%.

4. A method according to claim 3, wherein the applied pressure exceeds the required pressure in the canister by 10%.

5. A method according to claim 3, wherein the applied pressure exceeds the required pressure in the canister by 20%.

6. A method according to claim 1, wherein the applied pressure remains in force up to the time of sealing the canister and the canister aperture is sealed whilst the applied pressure is still being maintained.

7. A method according to claim 1, wherein the aperture is sized such that sufficient gas is allowed to freely come in to contact with the adsorbent and, once the canister is sealed, to achieve a pre-determined pressure in the canister interior.

8. A method according to claim 1, wherein the canister operates with a ‘bag-in-can’ mode of use.

9. A method according to claim 1, wherein the canister operates with a ‘bag-on-valve’ mode of use.

10. A method for manufacturing a canister from which a product is to be dispensed by means of a dispensing system comprising a solid/gas arrangement in which the gas is adsorbed onto the solid under pressure and desorbed therefrom when the pressure is released and in which the solid comprises an adsorbent for the gas and the gas comprises at least one of nitrogen, oxygen and mixtures thereof including air, carbon dioxide, nitrous oxide and argon, the container being adapted to be sealed and having valve means for dispensing the product by means of the pressure of the adsorbed gas, the method comprising the steps of: charging an adsorbent with a gas which is adsorbed thereby, keeping the adsorbent covered by such gas, installing the charged adsorbent under gas cover in the canister, filling the canister with the gas by applying pressurized gas to the adsorbent for additional adsorption thereof and closing and sealing the canister.
